(19) United States
(12) Patent Application Publication
(10) Pub. No.: US 2008/0259603 A1
(43) Pub. Date: Oct. 23, 2008

(54) LED-element

(75) Inventor: Robert Kraus, Regensburg (DE)

Correspondence Address: COHEN PONTANI LIEBERMAN & PAVANE LLP, Suite 1210, 551 Fifth Avenue, New York, NY, 10176, US

(73) Assignee: OSRAM Gesellschaft mit beschrankter Haftung, Munchen (DE)

(21) Appl. No.: 12/079,967

(22) Filed: Mar. 31, 2008

(30) Foreign Application Priority Data
Mar. 30, 2007 (DE) 10 2007 015 473.0

(51) Int. Cl. F21V 21/00; H05B 41/36

(52) U.S. Cl. 362/249; 315/294

(57) ABSTRACT

In an LED component comprising at least one LED (3) and at least one driver (2) for the LED (3), the at least one driver (2) and the at least one LED (3) are spaced apart from one another in such a way that a heat exchange between the driver (2) and the LED (3) takes place during operation of the LED (3).

### RELATED APPLICATION

This patent application claims the priority of German patent application 102007 015 473. 0 filed Mar. 30, 2007, the disclosure content of which is hereby incorporated by reference.

### FIELD OF THE INVENTION

The invention relates to an LED component comprising one or a plurality of LEDs.

### BACKGROUND OF THE INVENTION

LED components are generally operated with a voltage source that outputs a predetermined operating voltage for the LED component.

Since the brightness of an LED essentially depends on the operating current, it is desirable to generate with the operating voltage a defined predetermined current intensity through the one or the plurality of LEDs, in order to obtain a defined brightness. For this purpose, an LED or an LED module can be operated by means of a driver. The driver is an electronic component that converts the operating voltage into a predetermined current intensity. In this case, in the driver part of the electrical power consumed by the LED component can be converted into heat.

Despite the use of such a driver, which has the effect of causing a defined current intensity to flow through the LED or the plurality of LEDs of the LED component, it has been found that slight differences in the brightness and/or the color of LEDs of identical type can still continue to occur.

### SUMMARY OF THE INVENTION

An object of the invention is to provide an improved LED component with reduced brightness and color deviations in relation to LED components of identical type.

This and other objects are attained in accordance with one aspect of the present invention directed to an LED component comprising at least one LED and at least one driver for the LED, the at least one driver and the at least one LED are spaced apart from one another in such a way that a heat exchange between the driver and the LED takes place during operation of the LED.

The invention makes use of the insight, inter alia, that in LEDs which are operated with a predetermined current intensity by means of a driver, slightly different forward voltages of the LEDs can occur due to production, such that even LEDs of identical design consume slightly different powers. This can lead to differences in the operating temperature as a result of which, in particular, undesirable brightness or color deviations can occur.

The effect is counteracted by the heat exchange between the driver and the LED. This is based on the fact that during operation of the LED component with a predetermined operating voltage, in the case of an LED having a comparatively low forward voltage a larger proportion of the operating voltage is dropped across the driver, and a higher power consumption therefore takes place in the driver, than in the case of an LED having a higher forward voltage. Consequently, in the case of an LED in which, owing to a comparatively low forward voltage, somewhat less heat is generated than in an LED having a higher forward voltage, the driver is heated to a greater extent than in the case of an LED having a higher forward voltage. By virtue of the fact that the driver and the LED are spaced apart from one another in such a way that a heat exchange between the driver and the LED takes place during operation of the LED, a difference in the operating temperature between LEDs of identical type having different forward voltages due to production is therefore counteracted. Deviations in the color and/or the brightness of different LEDs that are caused by differences in the operating temperature are reduced in this way.

This is advantageous in particular for LED components, which contain a multiplicity of LEDs or LED chips which are arranged for example alongside one another or in the form of an array, and wherein a uniform illumination and minimal color deviations are desirable. This is the case for example in backlights for displays and LED high-power light sources.

The driver is understood to be an electronic component that is suitable for setting, using an operating voltage, a predetermined current intensity through the one or the plurality of LEDs of the LED component. The driver for the LED can be for example an electrical resistor, in particular an ohmic resistor. As an alternative, the driver can also comprise an electrical circuit containing for example one or a plurality of transistors. The driver can be integrated into a chip, for example.

The at least one LED is preferably an LED chip which has no LED housing. This is advantageous for the heat exchange between the driver and the LED. As an alternative, however, the LED chip can also be accommodated in an LED housing, preferably an LED housing having good thermal conductivity.

In order to obtain a good heat exchange between the LED and the driver, the LED and the driver are preferably arranged in direct proximity to one another. Preferably, the LED and the driver are spaced apart from one another by less than 1 cm. Particularly preferably, the distance between the LED and the driver is less than 0.5 cm.

In accordance with one embodiment, the at least one LED and the at least one driver are arranged on a common substrate. The substrate advantageously has a thermal conductivity of more than 10 Wm⁻¹K⁻¹. In this way, a good heat exchange between the driver and the LED is obtained, in particular by thermal conduction in the substrate.

The LED component can contain a plurality of LEDs, in particular a plurality of LED chips which are arranged for example on a common substrate. In this case, each of the plurality of LEDs can have a separate driver.

The plurality of LEDs can also be arranged in one or a plurality of groups, wherein each group of LEDs is assigned a common driver. In this case, each of the LEDs of a group is spaced apart from the common driver in such a way that a heat exchange between the common driver and a plurality of LEDs takes place during the operation of the plurality of LEDs. In particular, it is also possible for all the LEDs of the LED component to have a common driver.

Preferably, the plurality of LEDs of a group are in each case at the same distance from the common driver. This has the advantage that during the heat exchange between the driver and the LEDs, the heat is transferred uniformly to the LEDs, whereby deviations in the operating temperatures between the plurality of LEDs are reduced or even completely eliminated. In particular, the plurality of LEDs can be arranged around the common driver for example in a ring-shaped manner.

In a further embodiment, the at least one LED and the at least one driver are arranged on opposite sides of a thermally conductive substrate. In this case, the heat exchange between the LED and the driver is essentially effected by the thermal conduction through the substrate. In this case, it is advantageous if the substrate has a thermal conductivity of more than 10 Wm⁻¹K⁻¹. Furthermore, it is advantageous if the substrate is less than 2 mm thick.

In this embodiment, too, the LED component can comprise a plurality of LEDs. By way of example, each of the plurality of LEDs is assigned a separate driver, wherein the respective LED and the driver assigned to it are in each case opposite one another. By way of example, the plurality of LEDs are arranged on a first main area of the substrate, and the drivers are arranged on the opposite second main area of the substrate, wherein the LEDs and the driver assigned to the respective LED are not spaced apart from one another in a lateral direction.

### BRIEF DESCRIPTION OF THE DRAWINGS

FIG. 1 shows a schematic illustration of an LED component in accordance with a first exemplary embodiment of the invention,

FIG. 2 shows a schematic illustration of an LED component in accordance with a second exemplary embodiment of the invention,

FIG. 3 shows a schematic illustration of a cross section through an LED component in accordance with a third exemplary embodiment of the invention, and

FIG. 4 shows a schematic illustration of an LED component in accordance with a fourth exemplary embodiment of the invention.

### DETAILED DESCRIPTION OF THE DRAWINGS

Identical or identically acting elements are provided with the same reference symbols in the figures. The figures should not be regarded as true to scale, rather individual elements may be represented with an exaggerated size for illustration purposes.

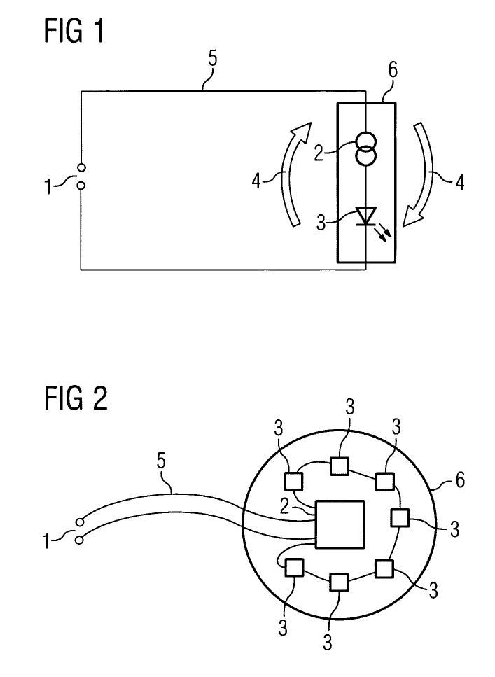

The LED component in accordance with a first exemplary embodiment as illustrated in FIG. 1 contains an LED 3 and a driver 2. The driver 2 and the LED 3 are connected to a voltage source 1 via current lines 5. The driver 2 is a means suitable for setting a defined current intensity through the LED 3, wherein the driver 2 and the LED 3 are connected in series, for example. By way of example, the driver 2 can be an electrical resistor, in particular an ohmic resistor. Furthermore, the driver 2 can however also be an electrical circuit containing for example one or a plurality of transistors. In particular, a driver 2 can be a circuit integrated into a chip.

The LED 3 is preferably an LED chip without a housing. As an alternative, however, an LED chip in an LED housing can also be involved.

The LED 3 and the driver 2 are spaced apart from one another in such a way that a heat exchange between the driver 2 and the LED 3 takes place during operation of the LED 3. This means that at least part of the heat emitted by the LED 3 is transferred to the driver 2, and that at least part of the heat emitted by the driver 2 is transferred to the LED 3, as is indicated by the arrows 4. The distance between the driver 2 and the LED 3 is advantageously less than 1 cm, preferably less than 0.5 cm.

In order to obtain a good heat exchange between the driver 2 and the LED 3, the driver 2 and the LED 3 are preferably arranged on a common substrate 6. The substrate 6 is preferably a thermally conductive substrate. In particular, the substrate 6 can contain a metal or a metal alloy such as, for example, Al, Cu or AlNi. By way of example, the substrate can be a metal-core circuit board, a printed circuit board or a metal substrate composed of a metal or metal alloy.

Particularly in the case of high-power LEDs or LED arrays it is advantageous if the thermally conductive substrate 6 has an active cooling, for example by means of a cooling liquid. For this purpose, microchannels through which a cooling liquid flows can be formed for example in the substrate.

By virtue of the fact that the driver 2 and the LED 3 are arranged in such a way that a heat exchange takes place between them during the operation of the LED component, the operating temperature of the LED is influenced, inter alia, by the heat liberated by the driver. In the case of the series connection of the driver 2 and the LED 3 as illustrated in FIG. 1, in the case of an LED 3 which has a comparatively low forward voltage in comparison with other LEDs and therefore only generates a small amount of heat, a higher proportion of the voltage generated by the voltage source 1 is dropped across the driver 2, such that a larger electrical power is converted into heat in the driver 2, than in the case of an LED having a higher forward voltage.

The heat exchange between the driver 2 and the LED 3 therefore brings about an increase in the operating temperature of the LED, such that a difference in the operating temperature with respect to a comparable LED having a higher forward voltage is reduced or even completely compensated for. The heat exchange between the driver 2 and the LED 3 therefore reduces differences in the operating temperatures of LEDs which have slightly different forward voltages due to production. Differences in the brightness and/or the color of the emitted light of the LEDs are reduced in this way.

The exemplary embodiment of an LED component as illustrated in FIG. 2 contains a plurality of LED chips 3. The plurality of LED chips 3 have a common driver 2, which is arranged with the LED chips 3 on a common substrate 6. The driver 2 is integrated into a chip, for example. For current supply, the driver 2 is connected to a voltage source 1 by means of current lines 5. The LEDs 3 are grouped around the common driver 2 in such a way that a heat exchange takes place between each of the LED chips 3 and the common driver 2 during the operation of the LED component. The LED chips 3 are arranged around the common driver 2 in a ring-shaped manner. As an alternative, it would also be possible to arrange the LEDs in a group for example centrally on the substrate and to arrange the driver in the form of an electronic circuit around the LEDs (not illustrated).

The plurality of LED chips 3 are advantageously in each case at the same distance from the common driver 2. The distance between the LED chips 3 and the common driver 2 is preferably less than 1 cm, particularly preferably less than 0.5 cm.

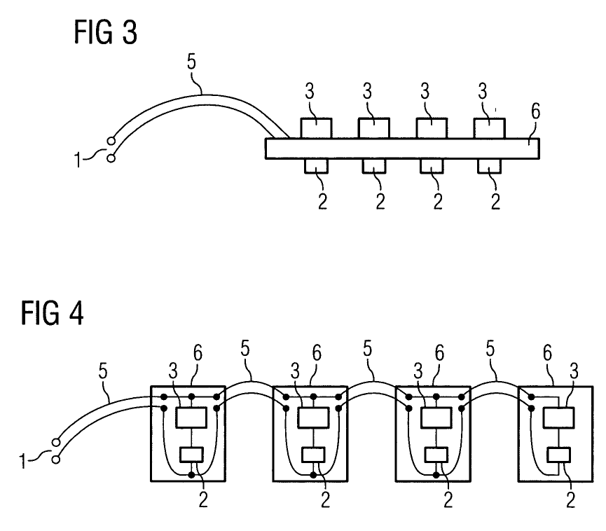

In the exemplary embodiment of an LED component as illustrated in FIG. 3, a plurality of LEDs 3 are arranged on a common substrate 6. In contrast to the exemplary embodiment illustrated in FIG. 2, the LEDs 3 do not have a common driver, but rather respectively separate drivers 2. In this case, each LED 3 is assigned a driver 2. The drivers 2 are preferably of the same type and thus have the same thermal characteristics. The drivers 2 are arranged on the opposite side of the substrate to the LEDs 3. In this case, each LED 3 is opposite the driver 2 assigned to it, that is to say that the LED 3 and the driver 2 assigned to it are not spaced apart from one another in a lateral direction, but rather only by the substrate 6. The heat exchange between the LEDs 3 and the drivers 2 assigned to them essentially takes place by thermal conduction through the thermally conductive substrate 6. Preferably, the thermally conductive substrate 6 has a thermal conductivity of more than 10 Wm⁻¹K⁻¹. In this exemplary embodiment of an LED component, it is advantageous if the substrate is comparatively thin. The thickness of the substrate is advantageously less than 2 mm.

The exemplary embodiment of an LED component as illustrated in FIG. 4 contains a plurality of LEDs 3, wherein each LED 3 together with a driver 2 assigned to it is arranged on a separate substrate 6. The LEDs 3 are connected in parallel by means of current lines 5. The LED component can be for example an illumination chain. By virtue of the fact that in the case of each LED 3 of the LED component, a heat exchange takes place between the LED 3 and the driver 2 assigned to it, brightness and color differences of the individual LEDs 3 which could otherwise occur as a result of different operating temperatures are reduced or even completely eliminated.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments.

We claim:

1. An LED component comprising at least one LED and at least one driver for the LED,
wherein the at least one driver and the at least one LED are spaced apart from one another in such a way that a heat exchange between the driver and the LED takes place during operation of the LED.

2. The LED component as claimed in claim 1,
wherein
the LED and the driver are spaced apart from one another by less than 1 cm.

3. The LED component as claimed in claim 2,
wherein
the LED and the driver are spaced apart from one another by less than 0.5 cm.

4. The LED component as claimed in claim 1,
wherein
the at least one LED and the at least one driver are arranged on a common substrate.

5. The LED component as claimed in claim 1,
wherein
the LED component comprises a plurality of LEDs.

6. The LED component as claimed in claim 5,
wherein
the plurality of LEDs are arranged in one or a plurality of groups, wherein the LEDs of a group have a common driver.

7. The LED component as claimed in claim 6,
wherein
the LEDs of a group are arranged around the common driver in such a way that they are in each case at the same distance from the driver.

8. The LED component as claimed in claim 6,
wherein
the plurality of LEDs of a group are arranged around the common driver in a ring-shaped manner.

9. The LED component as claimed in claim 1,
wherein
the at least one LED and the at least one driver are arranged on opposite sides of a thermally conductive substrate.

10. The LED component as claimed in claim 9,
wherein
the substrate has a thermal conductivity of more than 10 Wm⁻¹K⁻¹.

11. The LED component as claimed in claim 9,
wherein
the substrate is less than 2 mm thick.

12. The LED component as claimed in claim 9,
wherein
the LED component comprises a plurality of LEDs.

13. The LED component as claimed in claim 12,
wherein
each of the plurality of LEDs is assigned a separate driver, wherein the respective LED and the driver assigned to it are in each case opposite one another.

14. The LED component as claimed in claim 1,
wherein
the at least one LED is an LED chip without an LED housing.

15. The LED component as claimed in claim 4,
wherein
the substrate has a thermal conductivity of more than 10 Wm⁻¹K⁻¹.

16. The LED component as claimed in claim 15,
wherein
the LED component comprises a plurality of LEDs.

17. The LED component as claimed in claim 16,
wherein
each of the plurality of LEDs is assigned a separate driver, wherein the respective LED and the driver assigned to it are in each case opposite one another.
